(19) United States
(12) Patent Application Publication
(10) Pub. No.: US 2020/0008375 A1
(43) Pub. Date: Jan. 9, 2020

(54) SOIL-FREE CULTIVATION SYSTEM

(71) Applicants: Gabriel Rubanenko, Beverly Hills, CA (US); Valentin Hilitsky, Hollywood, CA (US)

(72) Inventors: Gabriel Rubanenko, Beverly Hills, CA (US); Valentin Hilitsky, Hollywood, CA (US)

(21) Appl. No.: 16/503,456

(22) Filed: Jul. 3, 2019

Related U.S. Application Data
(60) Provisional application No. 62/693,724, filed on Jul. 3, 2018.

(51) Int. Cl. A01G 31/02; F16M 11/42

(52) U.S. Cl. CPC A01G 31/02; F16M 11/42

(57) ABSTRACT

A soil-free cultivation system including a cultivation container into which a growing solution is conducted in order to cultivate plants, the cultivation container having two root compartments and a centrally positioned solution compartment.

### CROSS-REFERENCE TO RELATED APPLICATIONS

This application claims the benefit of priority under 35 U.S.C. § 120 from U.S. Patent Application No. 62/693,724, filed Jul. 3, 2018, the disclosure of which is incorporated herein by reference in its entirety.

### BACKGROUND

Soil-free systems for growing plants include hydroponic systems and aeroponic systems. In hydroponic systems, the roots of cultivated plants are suspended in a nutrient solution, while in aeroponic systems plant roots are generally suspended in the air and provided with a nutrient solution by spraying. Both types of systems avoid the use of soil or an aggregate medium.

The basic principle of aeroponic growing is to grow plants suspended in a closed or semi-closed environment by spraying the plant's roots and lower stem with an atomized or sprayed, nutrient-rich aqueous solution. The leaves and crown of growing plants extend above the roots, and for larger plants, trellising is used to suspend the weight of vegetation and fruit.

Both hydroponic and aeroponic systems, however, have disadvantages, including cost, scalability, and limitations on the variety of plants that can be cultivated. In view of the shrinkage of arable land in the world and significant population growth, improved soil-free cultivation methods are needed.

### FIGURES

FIG. 1 is a perspective view of a soil-free cultivation system, including a container and an irrigation system.

FIG. 2 is a perspective view of the soil-free cultivation system of FIG. 1, with the irrigation system removed from the container.

FIG. 3 is a perspective, exploded view of an end portion of the container of FIG. 1 illustrating inlet and outlet ports and respective inlet conduit and outlet conduit adapters.

FIG. 4 is a front perspective view of the container of FIG. 1 with its end walls removed.

FIG. 5 is a front elevation view of the end wall of the container of FIG. 1, showing the inlet port and the outlet port.

FIG. 6 is a rear elevation view of the end wall of the container of FIG. 1 that is opposite the end wall of FIG. 5.

FIG. 7 is a perspective view of the soil-free cultivation system of FIG. 1 with a cover on top of the container and placed on a support structure.

FIG. 8 is a perspective, exploded view of the support structure of FIG. 7.

FIG. 9 is a bottom plan view of a cover for the container of FIG. 1.

FIG. 10 is a top plan view of another cover for the container of FIG. 1.

The reference numbers in the drawings designate the following components of the present soil-free cultivation system:

| | | Reference |
|---|---|---|
| Component | Subcomponent | Number |
| cultivation system | | 100 |
| cultivation container | | 102 |
| cultivation container upper end | 101 | |
| cultivation container lower end | 103 | |
| cultivation container left side | 110 | |
| wall | | |
| cultivation container right side | 112 | |
| wall | | |
| cultivation container opposed | 111 | |
| sidewalls | | |
| cultivation container front end | 142 | |
| wall | | |
| cultivation container front end | 157 | |
| wall left side | | |
| cultivation container front end | 159 | |
| wall right side | | |
| cultivation container rear end | 144 | |
| wall | | |
| cultivation container rear end | 156 | |
| wall left side | | |
| cultivation container rear end | 158 | |
| wall right side | | |
| cultivation container interior | 146 | |
| root compartment | | 105 |
| left side root compartment | 104 | |
| right side root compartment | 106 | |
| left side bottom surface | 152 | |
| right side bottom surface | 154 | |
| bottom surface inner | 155 | |
| longitudinal edge | | |
| interior wall portions | 162 | |
| parallel slots | 164 | |
| gaps | 166 | |
| solution compartment | | 108 |
| solution compartment upper end | 172 | |
| solution compartment lower end | 174 | |
| solution compartment left side | 176 | |
| vertically extending sidewall | | |
| solution compartment right side | 178 | |
| vertically extending sidewall | | |
| solution compartment upper | 173 | |
| opening | | |
| solution compartment bottom | 175 | |
| surface | | |
| irrigation system | | 180 |
| fluid supply conduit | | 181 |
| fluid supply conduit proximal | 183 | |
| end | | |
| fluid supply conduit distal end | 185 | |
| fluid supply conduit upper | 187 | |
| surface | | |
| fluid supply conduit lower | 189 | |
| surface | | |
| water inlet | 182 | |
| water inlet connector | 192 | |
| water outlet | 188 | |
| water outlet connector | 198 | |
| riser pipe | | 184 |
| riser pipe upper end | 191 | |
| riser pipe lower end | 193 | |
| aerator | 186 | |
| cover | | 202 |
| cover upper surface | 201 | |
| cover lower surface | 203 | |
| stem holes or openings | 204 | |
| access holes | 206 | |
| removable hole covers | 208 | |
| support structure | | 210 |
| vertically extending support | 212 | |
| arms | | |
| framework | 215 | |
| horizontal portion | 222 | |
| first end of the horizontal | 226 | |
| portion | | |
| second end of the horizontal | 230 | |
| portion | | |
| framework opening | 232 | |
| vertical portion | 224 | |
| framework cross beams | 216 | |
| framework cross beam notch | 218 | |
| opening at the end of cross | 228 | |
| beam | | |
| framework elongated beam | 220 | |

### DESCRIPTION

### Definitions

As used herein, the following terms and variations thereof have the meanings given below, unless a different meaning is clearly intended by the context in which such term is used.

“Conduit” and “pipe” refer to enclosed channels, preferably tubular, for conducting fluids therethrough and having an opening at least at one end, preferably at both ends of the conduit.

“Crown” refers to the portions of a plant other than the roots, including stems, leaves, and reproductive structures, which are primarily located outside the root compartment of the present cultivation system.

“Downward” and “downwardly” mean in the direction of or toward a support surface on which the present apparatus is or can be positioned. “Upward” and “upwardly” mean in the opposite direction, i.e. away from such a support surface.

“Elongated” and “longitudinal” refer to a configuration or shape having a length which is longer than its width.

“Horizontal” refers to an orientation approximately parallel to (i.e., not substantially extending toward or away from) a support surface on which the present apparatus is supported when in use.

“Lower” and “below” refer to the relative position of a component of the present apparatus which is closer to or toward a support surface on which the present apparatus is or can be positioned.

“Nozzle” refers to a projecting conduit with an opening for regulating and/or directing a flow of fluid.

“Outward” and “outwardly” mean in a direction away from the horizontal or vertical center of the apparatus or of a component part of the apparatus.

“Upper” and “above” refer to the relative position of a component of the present apparatus which is further from or away from a support surface on which the present apparatus can be placed.

“Vertical” refers to an orientation extending toward or away from a support surface on which the present apparatus is supported when in use.

The term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise. Ranges which are described as being “between” two values include the indicated values. Terms relating to location and orientation (e.g., “upper,” “lower,” “right,” “left,” “front” “rear,” “exterior,” “interior,” “anterior,” “posterior,” etc.) are to be understood as being relative and not absolute terms. For example, “right” and “left” will thus be used to designate opposing lateral sides of components of the present article.

### Soil-Free Cultivation System

The present cultivation system 100 generally comprises a cultivation container 102, an irrigation system 180, and a cover 202. The cultivation container 102 has an upper end 101, a lower end 103, a left side wall 110 and right side wall 112 (together forming opposed sidewalls 111), a front end wall 142 having a left side 157 and right side 159, a rear end wall 144 having a left side 156 and right side 158, and an interior 146. The interior 146 of the cultivation container 102 includes two root compartments 105, a left side root compartment 104 and a right side root compartment 106. The left side root compartment 104 has a bottom surface 152 while the right side root compartment 106 has a right side bottom surface 154, each bottom surface having an inner longitudinal edge 155. The bottom surfaces 152 and 154 slope downwardly as they extends inwardly so that water or other solution (such as a solution including nutrients for plant growth) sprayed onto plants in the root container will generally flow from an outer portion of the cultivation container 102 (i.e., the right or left side of the cultivation container 102) toward an inner portion (the center).

The root compartments 105 further include interior wall portions 162 extending upwardly from the bottom surface of the root compartment and extending from the front to the rear of each root compartment. A plurality of interior wall portions 162 extend in parallel rows from the front end wall 142 to the rear end wall 144 and form parallel slots 164 which provide areas for plant roots to grow and be placed in contact with a nutrient solution. Advantageously, the interior wall portions 162 include one or more openings, holes, or gaps 166 along their longitudinal extent. Such gaps allow fluid flow from exterior to interior portions of the root compartment 105. In a preferred embodiment, as shown in the accompanying figures, a first interior wall portion of the left or right side root compartment is located inwardly of a second interior wall portion and the upper end of the first interior wall portion is lower than the upper end of the second interior wall portion. Additional, preferably parallel interior wall portions 162 can be used so that the upper ends of each successive wall portion 162 is lower than the wall portion adjacent on the outer side. This is to facilitate the flow of water or nutrient solution from an outer portion of a root compartment 105 toward the solution compartment 108 in the center of the cultivation container 102.

The solution compartment 108 of the cultivation container 102 extends from the front end wall 142 to the rear end wall 144 between the left side root compartment 104 and the right side root compartment 106, the solution compartment having an upper end 172, a lower end 174, a left side vertically extending sidewall 176, a right side vertically extending sidewall 178, an upper opening 173, and a bottom surface 175. The bottom surface 175 is positioned vertically below the bottom surfaces 152 and 154 of the left and right side root compartments and extends between the vertically extending sidewalls 176 and 178 of the solution compartment, while the upper ends of the right and left side vertically extending sidewalls are connected to the inner longitudinal edges of the bottom surface of the respective root compartments. In this way, fluid sprayed onto plants will flow from the root compartments 105 into the solution compartment 108 through the upper opening which extends between the inner longitudinal edge of the bottom surface of the left side root compartment and the inner longitudinal edge of the bottom surface of the right side root compartment. The attached components of the cultivation container 102 are generally in fluid tight engagement unless otherwise indicated in order to retain a nutrient solution within the cultivation container, allowing the solution to be recirculated as needed and reducing evaporative loss when a cover is placed over the cultivation container 102.

An irrigation system 180 is retained in the cultivation container 102, preferably extending longitudinally from the front to the rear of the container in the center. The irrigation system 180 generally includes a fluid supply conduit 181 having a proximal end 183, a distal end 185, an upper surface 187, a lower surface 189, a fluid inlet 182, and a fluid outlet 188. The conduit 181 conducts water or a nutrient solution into the cultivation container 102 and then into one or more riser pipes 184, from which the fluid is sprayed onto plants in the cultivation container 102. The riser pipes each generally include an upper end 191 in communication with an aerator 186 with one or more nozzles and a lower end 193 in fluid communication with the conduit 181.

The cultivation system 100 preferably further includes a cover 202 for enclosing the interior of the cultivation container 102 and the irrigation system 180. The cover has an upper surface 201 and a lower surface 203, as well as stem holes or openings 204 extending between the upper and lower surface. The stem openings 204 accommodate the stems of plants growing in the cultivation container 102 so that the leaf-containing portions of the plants can be situated outside the container and have access to light. Preferably, the cover 202 also includes larger-diameter access holes 206 so that workers can access the irrigation system and/or growing plants, as necessary. Removable hole covers 208 for the access holes 206 reduce evaporative loss.

The cultivation system 100 also preferably includes a support structure 210 for supporting the system above the ground, floor, or other support surface. The support structure 210 generally comprises a horizontal framework 215, which can include a horizontal portion 222. Preferably, the framework 215 further supports vertically extending support arms 212, which can be used to support the stems of plants growing in the cultivation container 102.

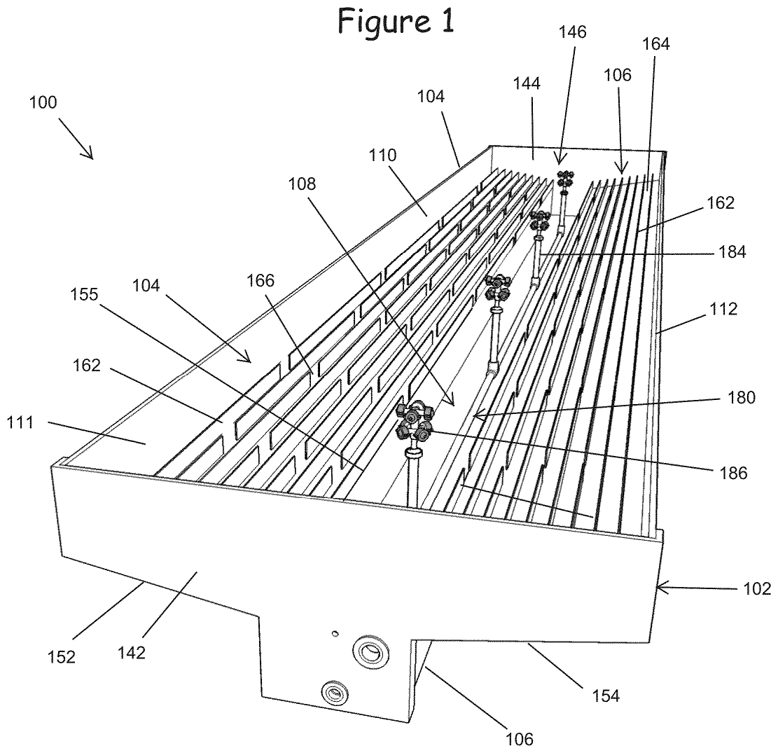

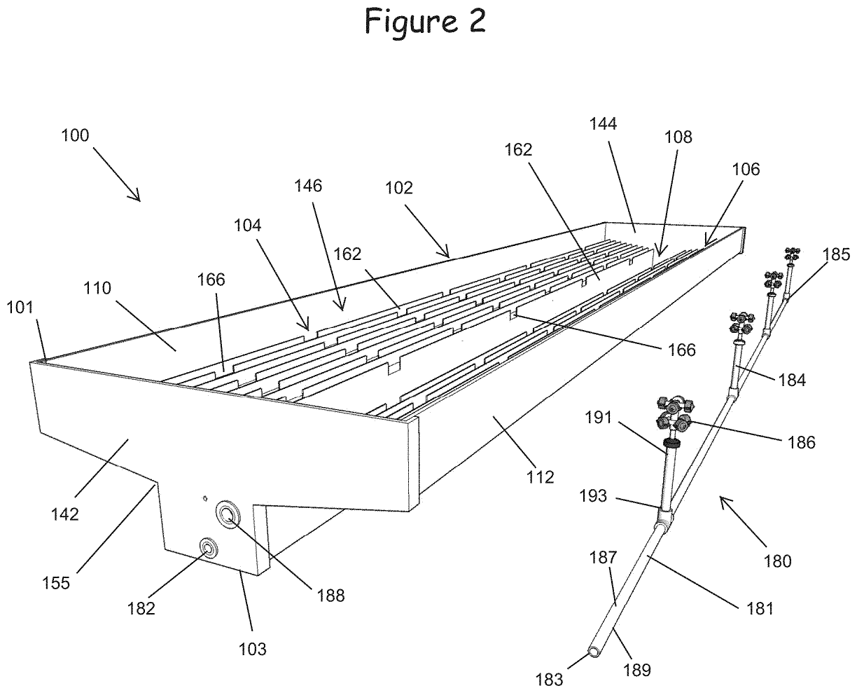

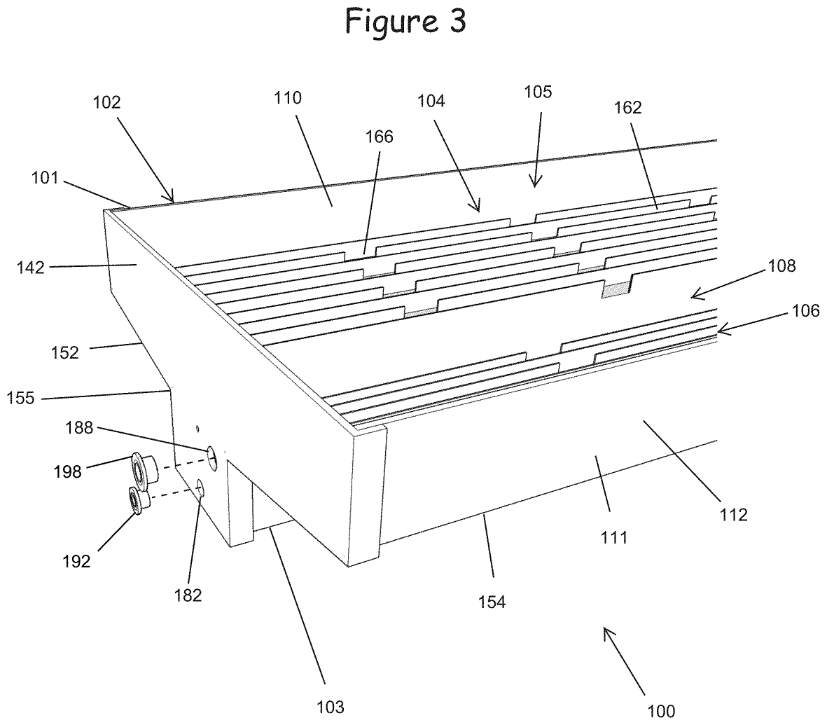

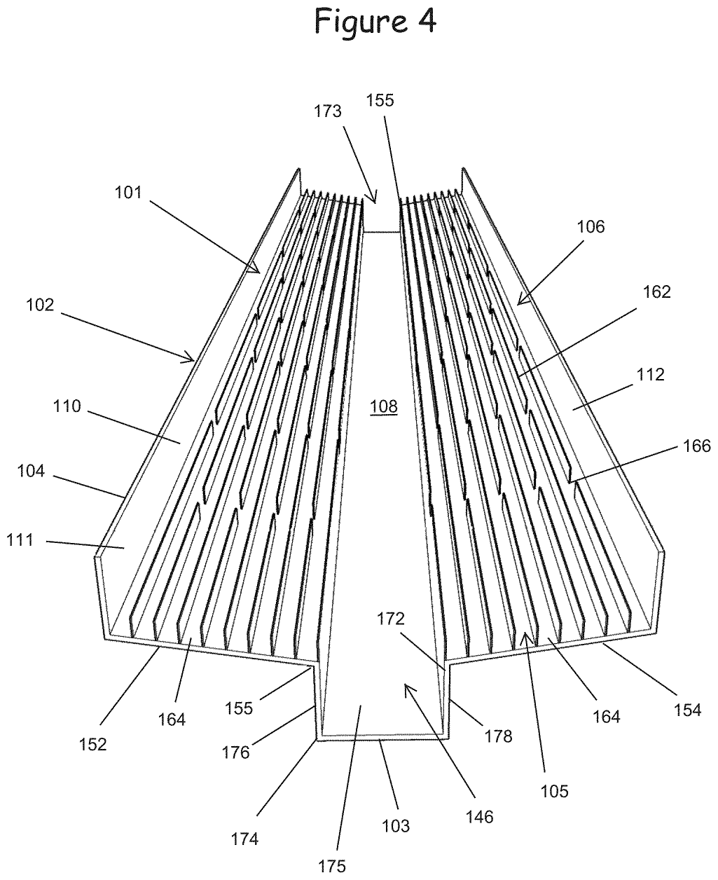

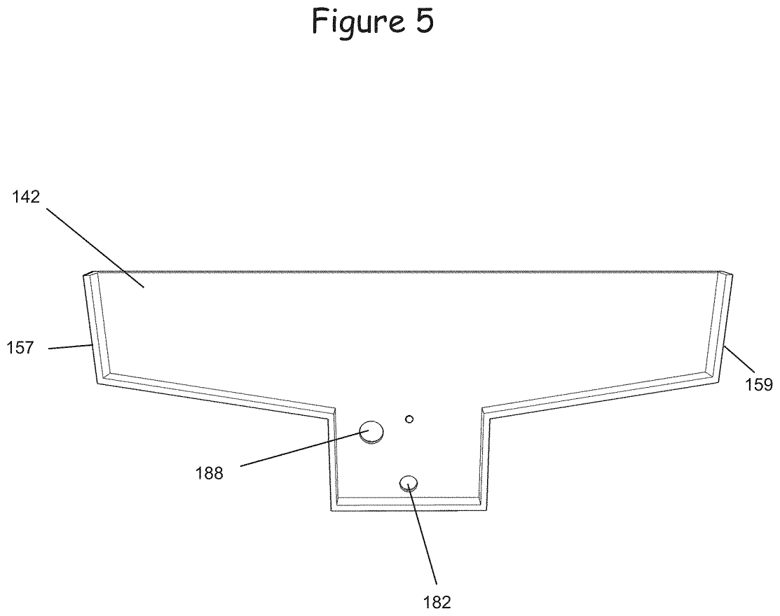

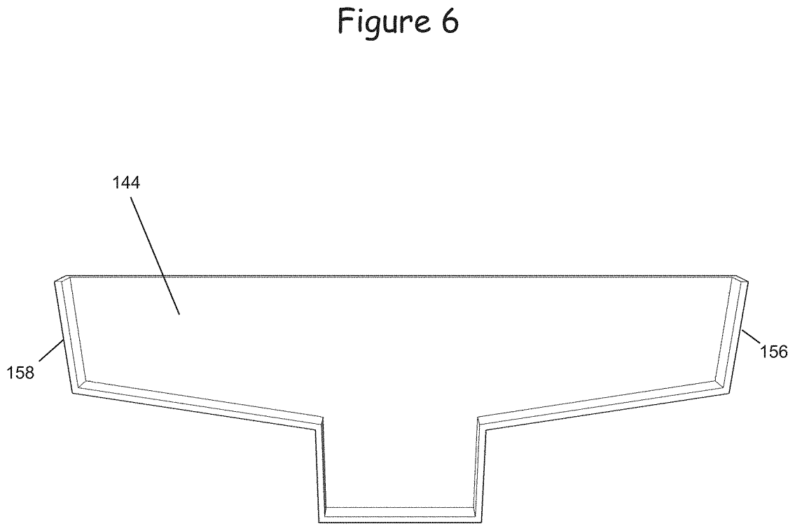

In one embodiment of the present cultivation system, a plant's roots are suspended adjacent the solution compartment 108, which acts as a reservoir of a nutrient solution. As shown in FIGS. 1-10, the present cultivation system 100 comprises a cultivation container or trough 102 which comprises a pair of root compartments 104, 106 on either side of a solution compartment 108. The cultivation container 102 includes a pair of opposed sidewalls 111, a left side wall 110 and a right side wall 112, a pair of opposed end walls 142, 144, and a pair of bottom surfaces 152, 154, each of which slop downward from a respective sidewall to the top of the solution compartment 108. In an alternate configuration, the cultivation container may include a single root compartment.

As described above, each root compartment 104, 106 generally comprises several separate wall portions 162 extending upwardly from a bottom surface 152, 154 and generally parallel to a respective one of the opposed sidewalls 110, 112. The wall portions 162 serve to retain plant roots and separate rows of plants. A series of separate wall portions 162 are arranged side by side to form a plurality of generally parallel slots 164 which extend along the length of the root compartments 104, 106. The wall portions 162 within a series are separated by gaps 166.

An irrigation system 180 is positioned in the solution compartment 108 and extends along the length of the cultivation container 102. The irrigation system 180 includes a fluid supply conduit 181 that is coupled to a water inlet 182 at one of the opposed end walls 114. A series of risers 184, each with an aerator 186 at its end, extend upward from the fluid supply conduit 181.

A low-pressure pump (not shown) delivers nutrient solution through a fluid supply conduit (not shown) coupled to the water inlet 182 which transports water or a nutrient solution, for example, to the irrigation system 180. The solution is dispersed within the cultivation container 102 through the aerators 186 which output the nutrient solution as a spray or mist, which is then delivered to the roots resting within the slots 164 on the interior of the root compartments 104, 106. Alternatively, the nutrient solution can be delivered as a mist generated by high-pressure pumps.

After contacting and/or condensing on the roots of plants, the nutrient solution then drips or drains onto the sloping bottom surfaces 152, 154 of the root compartments 104, 106, toward the gaps 166 and then downward into the solution compartment 108. After several, e.g., 3-4, applications of the nutrient solution, the solution level in the solution compartment 108 increases to the level of the water outlet 188 and is discharged through the water outlet and into a conduit (not shown) which is in fluid communication with the fluid supply conduit 181. Thus, the outlet 188 is advantageously positioned vertically above the inlet 182, though this is not crucial. In this way, nutrient solution which is sprayed onto the roots of a plant can be recirculated. The water outlet 188 is located below the level of the bottom surfaces 152, 154 of root compartments so that the fluid level in the solution compartment 108 does not rise to a level that reaches the root compartment. The roots of a plant in one of the root compartments will thereby be prevented from becoming submerged in the nutrient solution, thus preventing root rot.

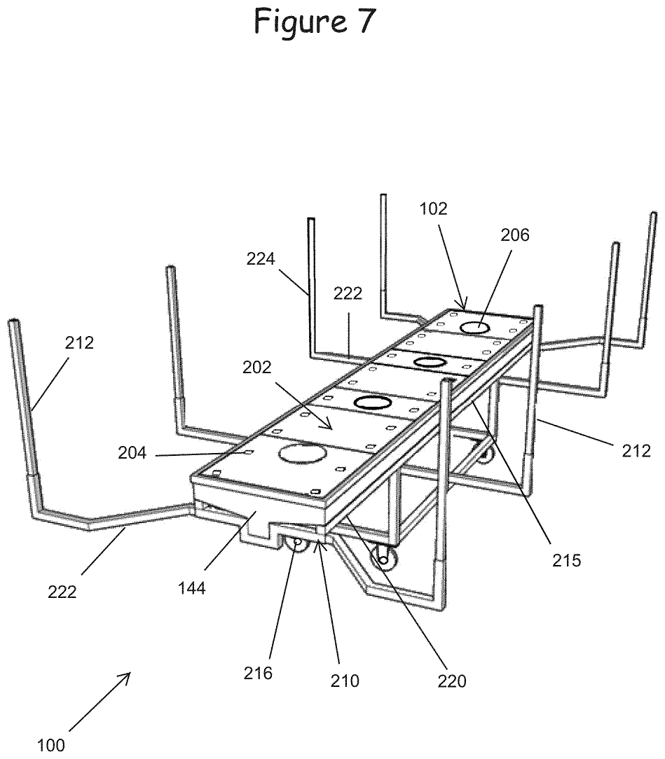

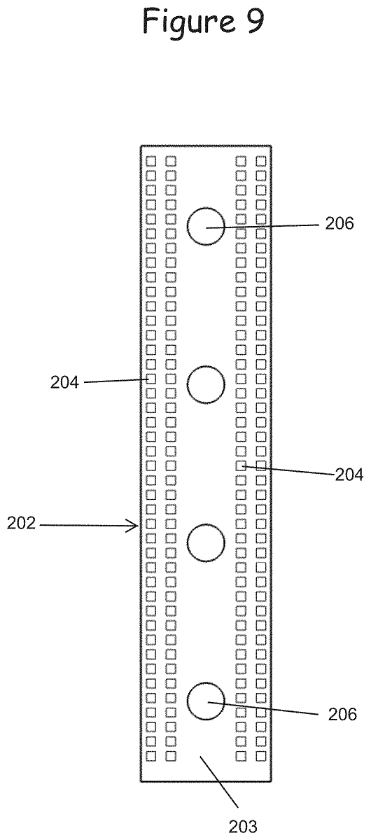

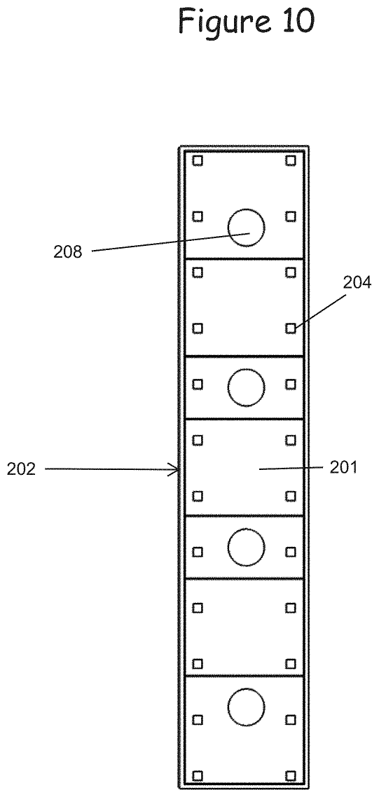

The present cultivation system 100 may include a cover. In one embodiment, as shown in FIG. 7, the present cultivation system 100 includes a cover 202 that is placed on top of the cultivation container 102 to protect the roots of the plants from over exposure to the environment and the nutrient solution from evaporation. The cover 202 is located above the aerators 186 so as not to interfere with the spraying of the nutrient solution by the aerators. The cover 202 includes stem openings 204 through which plant stems and branches, i.e. the crowns of plants whose roots are in the cultivation container 102, may extend. Access to the interior of the cultivation container 102 may be gained through access openings 206, which are preferably located along the length of the cover 202 to align with the aerators 186 of the irrigation system 180. Removable opening covers 208 may be placed over the access openings 206. Different configurations of covers 202 are contemplated. For example, as shown FIGS. 9 and 10, different numbers of stem openings 204 may be arranged along the length of the cover 202. The cover 202 selected for use may depend on the type of plant being cultivated.

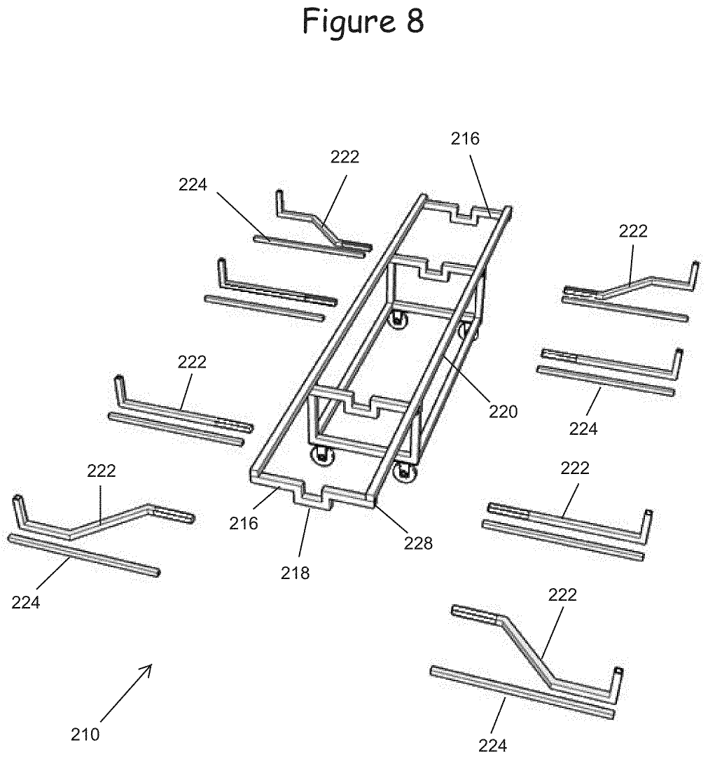

The present cultivation system 100 may be placed on a support structure that provides additional support for plants. In one embodiment, as shown in FIGS. 7 and 8, the present cultivation system 100 is placed on a support structure 210 that includes several support arms 212 that support stems and branches of plants that exit through the stem openings 204. The support structure 210 includes a main component (framework 215) upon which the cultivation container 102 may be placed. Cross beams 216 of the main component 215 preferably include a notch 218 that is sized to receive the solution compartment 108 of the cultivation container 102. The elongated beams 220 support the bottom surfaces of the root compartments.

The support arms 212 include a horizontal portion 222 that extends outward from the main component 214 and a vertical portion 224 that extends upward from the horizontal portion. A first end 226 of the horizontal portions 222 fit into an opening 228 at the end of the cross beams 216. The second end 230 of the horizontal portion 222 comprise a generally 90-degree elbow and has an opening 232 into which an end of a respective vertical portion 224 fits. One or more of the horizontal portions 222 may have a bent or curved configuration in order to evenly space the vertical portions 224 along the length of the support structure 210, as shown in FIG. 7.

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure.

Recitation of value ranges herein is merely intended to serve as a shorthand method for referring individually to each separate value falling within the range. Unless otherwise indicated herein, each individual value is incorporated into the specification as if it were individually recited herein. All references cited herein are incorporated by reference in their entirety.

What is claimed is:

1. A cultivation system for growing plants comprising:
(1) a cultivation container comprising an upper end, a lower end, a right side wall, a left side wall, a front end wall, a rear end wall, an interior, an inlet and an outlet, wherein the cultivation container further comprises:
(a) a left side root compartment extending from the front end wall to the rear end wall at an upper end of the cultivation container and extending inwardly from the left side wall, the left side root compartment further comprising:
(i) a bottom surface extending from the front end wall to the rear end wall and extending inwardly from the left side wall below the upper end of the cultivation container to an inner longitudinal edge, wherein the bottom surface slopes downwardly as it extends inwardly;
(ii) a plurality of interior wall portions having an upper end and a lower end and extending upwardly from the bottom surface of the left side root compartment, wherein the interior wall portions extend in parallel rows from the front end wall to the rear end wall, and wherein the interior wall portions include one or more openings;
(b) a right side root compartment extending from the front end wall to the rear end wall at an upper end of the cultivation container and extending inwardly from the right side wall, the left side root compartment further comprising:
(i) a bottom surface extending from the front end wall to the rear end wall and extending inwardly from the right side wall below the upper end of the cultivation container to an inner longitudinal edge, wherein the bottom surface slopes downwardly as it extends inwardly;
(ii) a plurality of interior wall portions having an upper end and a lower end and extending upwardly from the bottom surface of the right side root compartment, wherein the interior wall portions extend in parallel rows from the front end wall to the rear end wall, and wherein the interior wall portions include one or more openings;
(c) a solution compartment between the left side root compartment and the right side root compartment, the solution compartment comprising an upper end, a lower end, an exterior surface, an interior surface, a left side vertically extending sidewall, a right side vertically extending sidewall, an upper opening, and a bottom surface, wherein:
(i) the bottom surface is positioned vertically below the bottom surfaces of the left side root compartment and the right side root compartment and extends between the vertically extending sidewalls of the solution compartment;
(ii) the upper end of the left side vertically extending sidewall is connected to the inner longitudinal edge of the bottom surface of the left side root compartment;
(iii) the upper end of the right side vertically extending sidewall is connected to the inner longitudinal edge of the bottom surface of the right side root compartment; and
(iv) the upper opening extends between the inner longitudinal edge of the bottom surface of the left side root compartment and the inner longitudinal edge of the bottom surface of the right side root compartment;
(2) an irrigation system comprising:
(a) a supply conduit having a proximal end, a distal end, an upper surface, a lower surface, and one or more openings in an upper surface of the supply conduit, wherein the proximal end is in fluid communication with the inlet of the cultivation container;
(b) a riser pipe having an upper end with an upper opening and a lower end with a lower opening, wherein the lower opening is in fluid communication with one of the openings in the upper surface of the supply conduit, and wherein the upper opening is in fluid communication with a nozzle having one or more nozzle openings to allow the passage of fluid therethrough; and
(3) a cover for enclosing the interior of the cultivation container and the irrigation system, the cover having an upper surface and a lower surface and extending horizontally from the front end wall to the rear end wall at an upper end of the cultivation container, wherein the cover further comprises a plurality of stem openings to allow a portion of a plant being grown in the cultivation container to pass therethrough.

2. The cultivation system of claim 1, further comprising a support structure for holding the cultivation container above a support surface, wherein the support structure comprises a horizontal framework supporting the lower end of the cultivation container.

3. The cultivation system of claim 2, further comprising vertically extending support arms connected to the framework.

4. The cultivation system of claim 1, wherein the framework is supported above a support surface by wheels.

5. The cultivation system of claim 1, wherein the cover further includes access openings, and wherein the access openings have a larger area than the stem openings.

6. The cultivation system of claim 5, further comprising cover plates to reversibly close the access openings.

7. The cultivation system of claim 1, wherein a first interior wall portion of the left side root compartment is located inwardly of a second interior wall portion of the left side root compartment and the upper end of the first interior wall portion of the left side root compartment is lower than the upper end of the second interior wall portion of the left side root compartment.

8. The cultivation system of claim 1, wherein a first interior wall portion of the right side root compartment is located inwardly of a second interior wall portion of the right side root compartment and the upper end of the first interior wall portion of the right side root compartment is lower than the upper end of the second interior wall portion of the right side root compartment.
